(19) United States
(12) Patent Application Publication
(10) Pub. No.: US 2010/0320784 A1
(43) Pub. Date: Dec. 23, 2010

(54) Hollow shaft barbeque tool

(76) Inventor: James Rosenbaum, Carmichael, CA (US)

Correspondence Address: Risso & Associates, 7350 West 85th Street, Los Angeles, CA, 90045, US

(21) Appl. No.: 12/584,314

(22) Filed: Sep. 3, 2009

Related U.S. Application Data
(60) Provisional application No. 61/269,132, filed on Jun. 22, 2009.

(51) Int. Cl. B65G 7/12

(52) U.S. Cl. 294/26

(57) ABSTRACT

A hollow shaft barbeque tool is described. The tool includes a hollow shaft cylindrically tapering from a first end to a second end. The first end has a first diameter and the second end has a second diameter such that the second diameter is less than the first diameter, thereby creating the tapering form. A grip is attached with the first end of the hollow shaft to allow a user to grasp the tool. A tip receiver is press fit in the second end of the hollow shaft, with a solid turning tip press fit into the tip receiver. Thus, a user can use the turning tip to grasp and turn a piece of meat food while barbequing the meat food.

### PRIORITY CLAIM

The present application is a Non-Provisional Utility Patent Application of U.S. Provisional Application No. 61/269,132, filed on Jun. 22, 2009, entitled, “Hollow Shaft BBQ Food Turner.”

### BACKGROUND OF THE INVENTION

(1) Field of Invention

The present invention relates to a barbeque grilling tool and, more particularly, to a hollow shaft barbeque tool with a turning tip to grasp and turn a piece of food while barbequing the food.

(2) Description of Related Art

Grilling meat and other foods on a barbeque grill has long been a favored method of cooking. In grilling meats, the meat is typically placed on the barbeque grill and allowed to cook for a certain amount of time. At some point, it is desirable to move or turn the meat food. However, due to the intense heat emanating from the grill, a user cannot simply grasp and turn the meat food. Thus, to assist the user in moving the meat, a plethora of prongs, forks, and turning utensils have been devised.

Existing turning utensils are typically formed in one of two ways; either they are formed of a single, solid piece of metal, or they are a combination of solid metal with a wood handle. The inherent downside of a single, solid piece of metal is that the heat from the barbeque grill and meat is quickly transferred to the user's hand as the user grasps the tool. Alternatively, an inherent downside to the combination of solid metal with a wood handle is that the wood degrades over time and, further, does not provide the strength of an all metal tool.

Thus, a continuing need exists for a barbeque turning tool that possesses the strength of an all metal tool, yet does not quickly transfer heat to the user's hand while grasping the tool.

### SUMMARY OF INVENTION

The present invention relates to a hollow shaft barbeque tool. The tool comprises a hollow shaft cylindrically tapering from a first end to a second end. The shaft is formed such that the first end has a first diameter and the second end has a second diameter, where the second diameter is less than the first diameter. A grip is attached with the first end of the hollow shaft. Alternatively, a tip receiver is attached with the second end of the hollow shaft. Finally, a solid turning tip is press fit into the tip receiver. Thus, a user can use the turning tip to grasp and turn a piece of food (e.g., meat, vegetable, etc.) while barbequing the food.

In another aspect, the grip (e.g., golf club grip) is circumferentially disposed around the first end of the hollow shaft. The grip is formed of a transparent material and includes indicia attached therewith that is visible through the grip. The indicia includes an item selected from a group consisting of a logo and an organization name.

Additionally, each of the tip receiver and the turning tip are formed of any suitably durable material, a non-limiting example of which includes stainless steel.

In yet another aspect, the tip receiver is a tapered tip receiver. The tip receiver is attached with the second end of the hollow shaft in a manner selected from a group consisting of being press fit into the hollow shaft, being sleeved over the second end of the hollow shaft, being positioned within the hollow shaft with a pin passing through both the hollow shaft and the tip receiver, and being screwed into the hollow shaft via threads.

Finally, as can be appreciated by one in the art, the present invention also comprises a method for forming and using the hollow shaft barbeque tool described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is a perspective-view illustration of a barbeque tool according to the present invention;

FIG. 1B is a perspective-view illustration of the barbeque, depicting a collapsible configuration;

FIG. 2 is a close-up, perspective-view illustration of a grip according to the present invention;

FIG. 3A provides a close-up, cross-sectional, side view illustration of a turning tip, tip receiver, and hollow shaft according to the present invention;

FIG. 3B is an illustration depicting the tip receiver connected with the hollow shaft;

FIG. 3C is an illustration depicting the tip receiver connected with the hollow shaft;

FIG. 3D is an illustration depicting the tip receiver connected with the hollow shaft; and

FIG. 4 is a top-view illustration of a turning tip and tip receiver according to the present invention.

### DETAILED DESCRIPTION

The present invention relates to a barbeque grilling tool and, more particularly, to a hollow shaft barbeque tool with a turning tip to grasp and turn a piece of food while barbequing the food. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

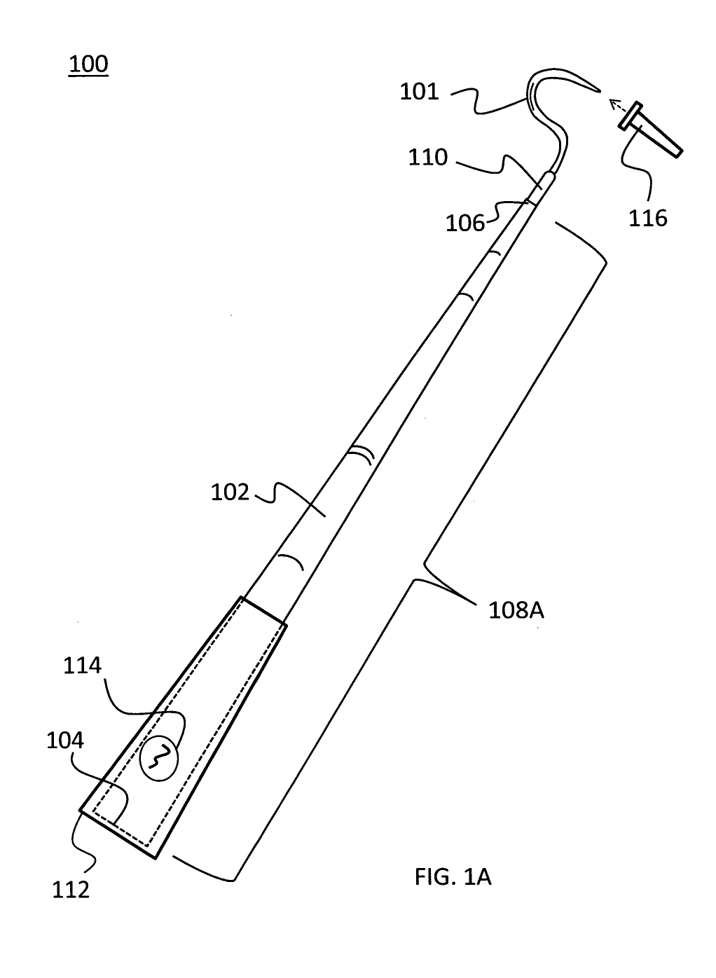

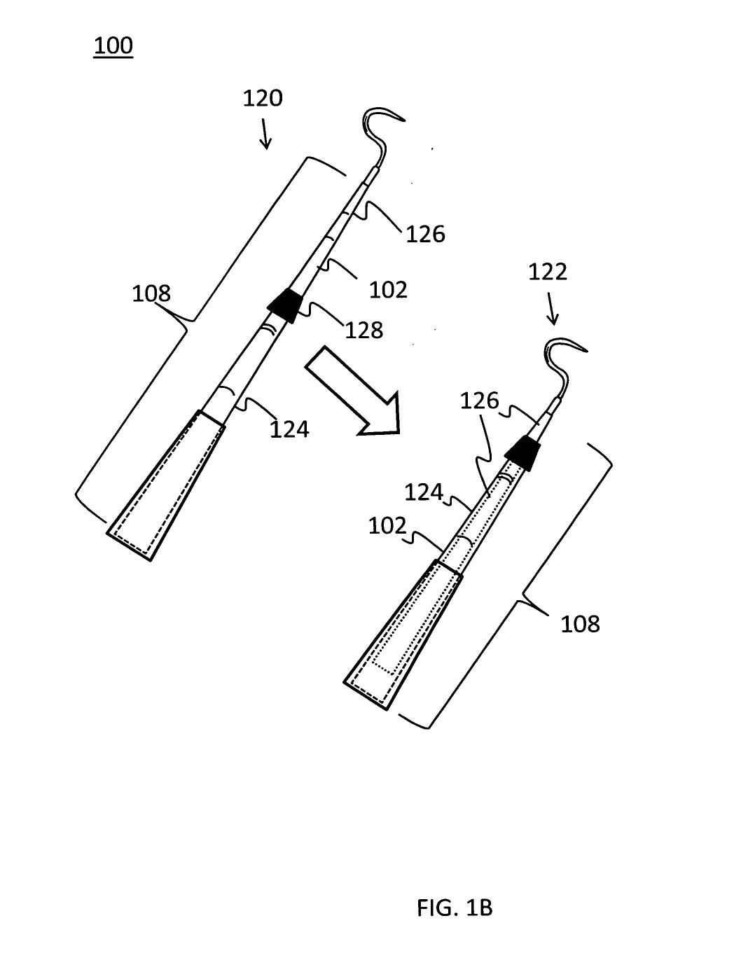

When cooking on a gas, electric, or wood fired barbeque, there are many tools which can turn food. However, existing tools suffer from poor design as they quickly pass the heat emanating from a barbeque grill to the handle of the tool. As shown in FIG. 1A, the present invention improves upon the prior art by providing a cylindrically tapered, hollow shaft barbeque tool 100. The barbeque tool 100 accomplishes the turning of food by the action of piercing the food with a stainless steel turning tip 101, and through a simple lifting and flipping action, the food is quickly and efficiently turned over to allow even cooking of the food.

The barbeque tool 100 includes a cylindrically tapered, hollow shaft 102. The hollow shaft 102 is formed of any suitably durable metal, non-limiting examples of which include being formed of iron with a plated chrome exterior and stainless steel.

In another aspect, the hollow shaft 102 is tapered from a first end 104 to a second end 106. The first end 104 has a first diameter and the second end 106 has a second diameter such that the second diameter is less than the first diameter. Thus, hollow shaft 102 is tapered along the shaft length 108, narrowing at the tip (i.e., the second end 106). As can be understood by one skilled in the art, the tapering along the length 108 of the hollow shaft 102 provides added strength to the tool 100 and can be accomplished via a smooth tapered bore (or other suitable technique).

The hollow shaft 102 is formed of any suitable dimension to allow a user to grasp a piece of food for a hot barbeque grill at length. As a non-limiting example, the hollow shaft has a length of 57.9 centimeters, with an approximate first diameter of 1.49 centimeters, which tapers to a second diameter of approximately 1.0 centimeter.

As shown in FIG. 1B, the tool 100 can be formed such that the shaft length 108 of the hollow shaft 102 is adjustable. In other words, the hollow shaft 102 can be formed to be collapsible to collapse from an extended position 120 to a collapsed position 122. As a collapsible shaft, the hollow shaft 102 includes an outer shaft 124 and an inner shaft 126. The inner shaft 126 can be slid into the outer shaft 124 to reduce the length 108 of the shaft. An adjustment mechanism 128 can be included that allows a user to fix the inner shaft 126 with the outer shaft 124 at a desired length within the shaft length 108, thereby allowing a user to adjust the device to a preferred length in the cooking process (or for storage). For example, it may be desirable to shorten the length to accommodate a smaller barbecue's cooking surface. The adjustment mechanism 128 is any suitable mechanism or device for affixing two telescoping rods with one another, a non-limiting example of which includes a screw type sleeve that tightens the shafts against one another.

Referring again to FIG. 1A, as noted herein, the shaft 102 is hollow and, as such, includes an inner diameter formed as a result of the thickness of the walls of the hollow shaft 102. The inner diameter possesses any suitable dimension to maintain a hollow configuration along the length 108 of the hollow shaft 102 and to be able to receive a tip receiver 110 (described in further detail below), non-limiting examples of which include having a first inner diameter of approximately 1.31 centimeters which tapers to a second inner diameter at the second end 106. Due to the hollow shaft 102 design, the tool 100 is highly resistant to indirect heat and dissipates heat quickly.

To provide further thermal insulation, the tool 100 also includes a protective grip 112 fixed to the first end 104 of the shaft 102. The grip 112 provides additional thermal insulation protection and provides excellent non-slip gripping of the device when in use. The grip 112 is any suitable mechanism or device that is capable of providing thermal insulation and added gripping characteristics, non-limiting examples of which includes being a rubber golf club grip (e.g., textured grip or tacky grip) or a custom designed wooden handle. It should also be noted that other suitable materials can be used to create such grips 112.

The grip 112 can also be formed to include indicia 114 that is visible through the grip 112 or embedded in the grip 112. For example, the grip 112 can be formed of a transparent material that would allow a user to view the indicia 114 that is positioned within the grip 112. The indicia 114 is any suitable item that provides a display element, a non-limiting example of which includes a disk with a logo or organizational name printed thereon. For example, the name of a sport team or an image can be printed on a disk (e.g., one-sided sticky logo decal), which serves as the indicia 114 and is embedded within the grip 112.

At the other end (i.e., second end 106) of the hollow shaft 102 is a tip receiver 110 that is connected with the second end 106. The tip receiver 110 can be formed of any suitably durable material, non-limiting examples of which include stainless steel and chrome plated steel. Further, the tip receiver 110 can be formed in any suitable shape, non-limiting examples of which include being cylindrical and being cylindrically tapered. Additionally, the tip receiver 110 can be formed in any suitable dimension, non-limiting examples of which including having a length of approximately 22 millimeters, with an approximate maximum diameter of 8.5 millimeters, which tapers to approximately 5 millimeters at the terminal end.

Attached with the tip receiver 110 is the solid turning tip 101. The turning tip 101 allows the user to grasp and turn a piece of food while barbequing the food. As can be appreciated by one skilled in the art, the turning tip 101 is suitable for turning any type of piercable food, non-limiting examples of which include meat food, vegetables, chicken, fish, etc. The turning tip 101 is formed of any suitable material, non-limiting examples of which include stainless steel and chrome plated steel. It should also be noted that the turning tip 101 can be formed to turn either to the left or right to accommodate right-handed and left-handed people, respectively.

The turning tip 101 is attached with the tip receiver 110 via any suitable technique for attaching such items, a non-limiting example of which includes being press fit into the tip receiver 110. In this aspect, the turning tip 101 is press fit into a hollow shaft bore of the tip receiver 110. For example, the turning tip 101 has a diameter of 3.6 millimeters while the hollow shaft bore is 3.5 millimeters, whereby press fitting the turning tip 101 into the hollow shaft bore creates a tight and solid fixture between the two items. To further affix the turning tip 101 to the tip receiver 110, the turning tip 101 is welded (as described in further detail below) onto the end of the tip receiver 110.

It should also be noted that the turning tip 101 ends in a sharp point that can be used to easily pierce meat and other food items. To protect the user, a protective cap 116 can be included. The protective cap 116 is a casing that can be used to cover the sharp point of the turning tip 101.

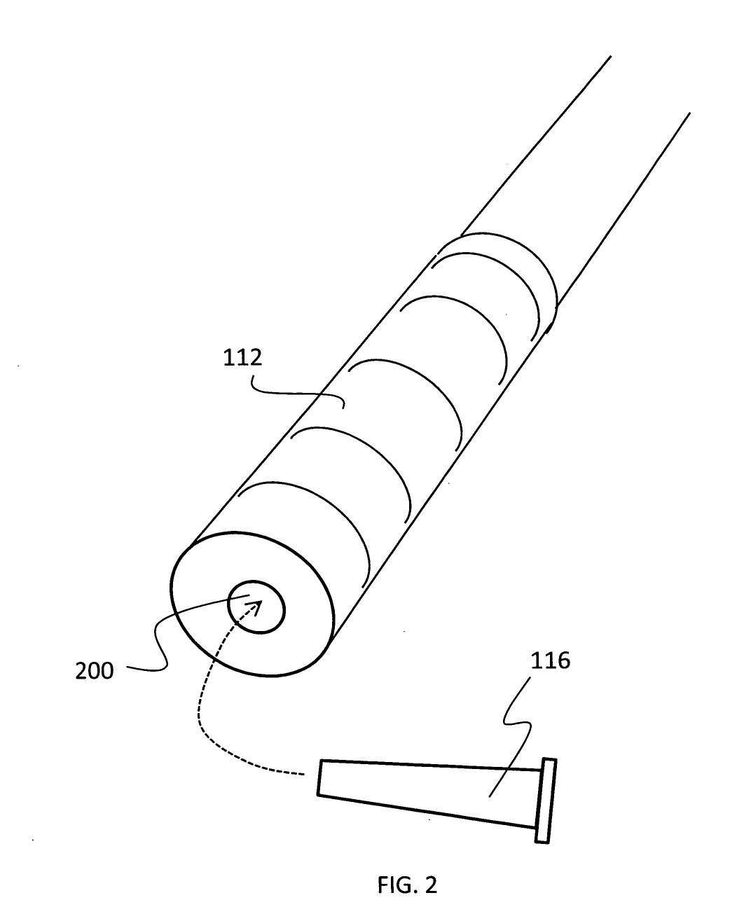

While using the tool 100, it may be desirable to store or stow away the protective cap 116. As such and as shown in FIG. 2, the grip 112 can be formed such that a ventilation hole 200 at the end of the grip 112 can accommodate and store the protective cap 116. For example, the ventilation hole 200 is formed as a sleeve or at least large enough to accommodate the protective cap 116.

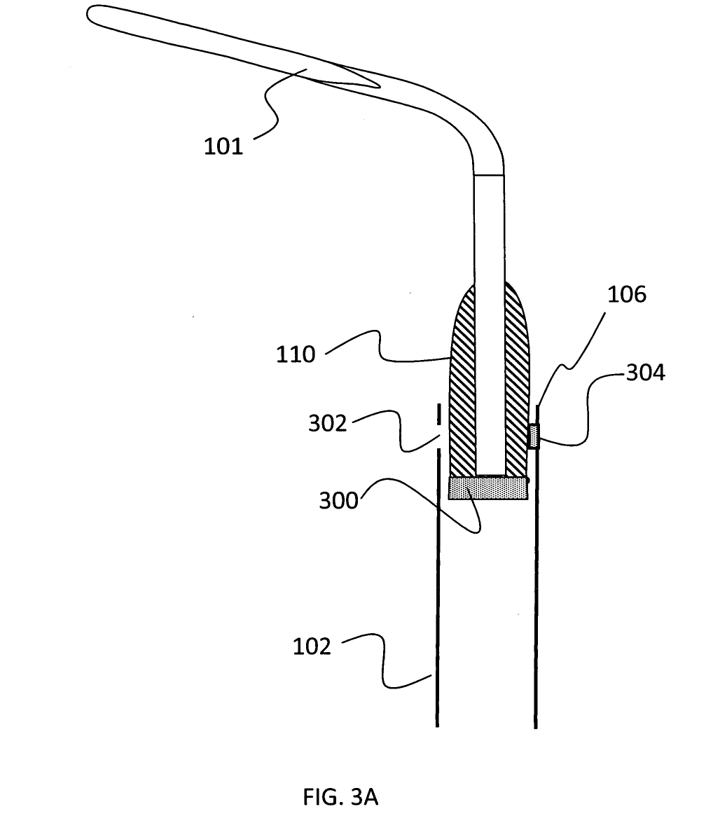

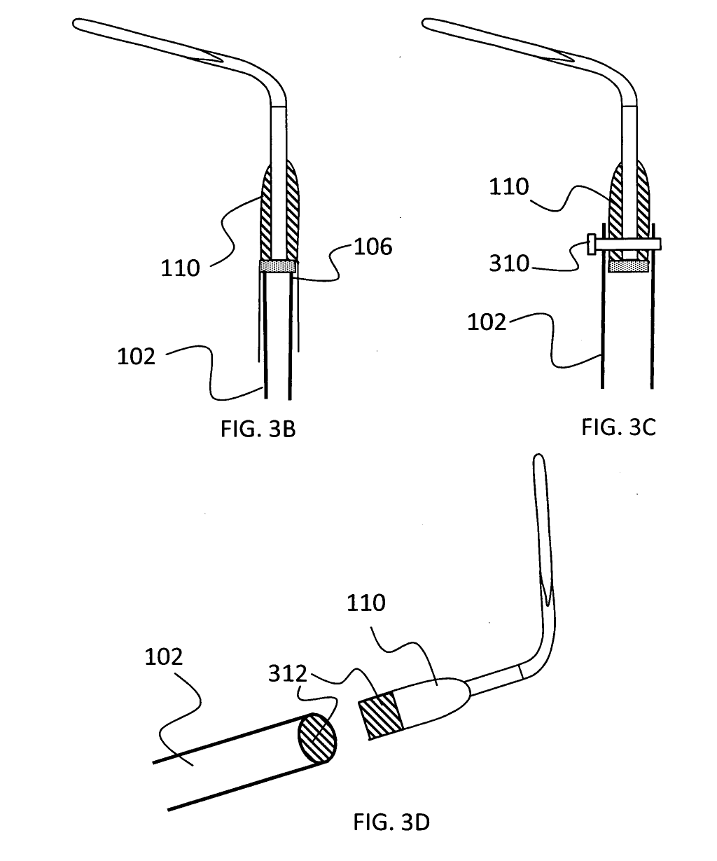

As shown in FIG. 3A and referring again to the tip receiver 110, the tip receiver 110 is press fit into the hollow shaft 102. FIG. 3A provides a close-up, cross-sectional side view illustration of the turning tip 101, the tip receiver 110, and the hollow shaft 102. Further, the turning tip 101 is welded 300 on the hidden side of the tip receiver 110. The turning tip 101 is first pressed into the bore of the tip receiver 110 and then welded 300 on the end, which is then inserted (e.g., press fit) into the hollow shaft 102.

However, prior to insertion of the tip receiver 110, holes 302 can be drilled into the hollow shaft 102. Thus, once the tip receiver 110 is pressed into the hollow shaft 102, the tip receiver 100 can be welded 304 to the hollow shaft 102 at each of the holes 302, with the weld 304 thereafter polished smooth.

As can be appreciated by one skilled in the art, the tip receiver 110 is connected with the second end 106 of the hollow shaft 102 through any suitable technique for connecting such items, non-limiting examples of which include: the tip receiver 110 being press fit into the hollow shaft 102 (as shown in FIG. 3A); the tip receiver 110 “sleeved” over the second end 106 of the hollow shaft 102 and silver soldered to the shaft 102 (as shown in FIG. 3B); the tip receiver 110 positioned within or over the hollow shaft 102 with a “pin thru” arrangement where a pin 310 is positioned through both the hollow shaft 102 and tip receiver 110 to affix the two items together (as shown in FIG. 3C); and a “screw on” type of arrangement where the tip receiver 110 is screwed into or onto the hollow shaft 102 via threads 312 or other screw-type configurations (as shown in FIG. 3D).

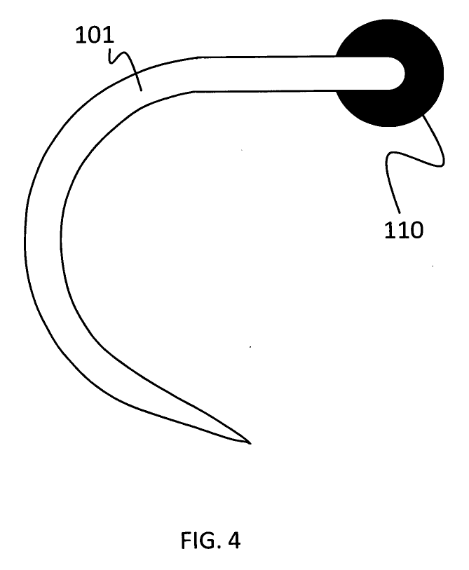

As noted in FIGS. 1A, 3A, 3B, 3C and 3D, the turning tip 101 is formed to curl around or otherwise be in an arcuate form. FIG. 1A illustrates a perspective-view of the turning tip 101 while FIGS. 3A through 3D illustrates a side-view of the turning tip 101. For further illustration, FIG. 4 provides a top-view illustration of the turning tip 101, depicting its curling form as it extends from the tip receiver 110. The curling form further assists the user in grasping and turning food items. Thus, a user can use the turning tip 101 to grasp and safely turn a piece of meat food while barbequing the meat food on a hot grill.

What is claimed is:

1. A hollow shaft barbeque tool, comprising:
a hollow shaft cylindrically tapering from a first end to a second end, wherein the first end has a first diameter and the second end has a second diameter such that the second diameter is less than the first diameter;
a grip attached with the first end of the hollow shaft;
a tip receiver attached with the second end of the hollow shaft; and
a solid turning tip press fit into the tip receiver, whereby a user can use the turning tip to grasp and turn a piece of food while barbequing the food.

2. The hollow shaft barbeque tool as set forth in claim 1, wherein the grip is circumferentially disposed around the first end of the hollow shaft.

3. The hollow shaft barbeque tool as set forth in claim 2, wherein the grip is a golf club grip.

4. The hollow shaft barbeque tool as set forth in claim 3, wherein the grip is formed of a transparent material and includes indicia attached therewith that is visible through the grip.

5. The hollow shaft barbeque tool as set forth in claim 4, wherein the indicia includes an item selected from a group consisting of a logo and organization name.

6. The hollow shaft barbeque tool as set forth in claim 5, wherein the tip receiver is a tapered tip receiver.

7. The hollow shaft barbeque tool as set forth in claim 6, wherein each of the tip receiver and the turning tip are formed of stainless steel.

8. The hollow shaft barbeque tool as set forth in claim 7, wherein the tip receiver is attached with the second end of the hollow shaft in a manner selected from a group consisting of being press fit into the hollow shaft, being sleeved over the second end of the hollow shaft, being positioned within the hollow shaft with a pin passing through both the hollow shaft and the tip receiver, and being screwed into the hollow shaft via threads.

9. The hollow shaft barbeque tool as set forth in claim 8, wherein the hollow shaft is formed to be collapsible from an extended position to a collapsed position.

10. The hollow shaft barbeque tool as set forth in claim 1, wherein the grip is a golf club grip.

11. The hollow shaft barbeque tool as set forth in claim 1, wherein the grip is formed of a transparent material and includes indicia attached therewith that is visible through the grip.

12. The hollow shaft barbeque tool as set forth in claim 11, wherein the indicia includes an item selected from a group consisting of a logo and organization name.

13. The hollow shaft barbeque tool as set forth in claim 1, wherein the tip receiver is a tapered tip receiver.

14. The hollow shaft barbeque tool as set forth in claim 1, wherein each of the tip receiver and the turning tip are formed of stainless steel.

15. The hollow shaft barbeque tool as set forth in claim 1, wherein the tip receiver is press fit into the hollow shaft.

16. The hollow shaft barbeque tool as set forth in claim 1, wherein the tip receiver is sleeved over the second end of the hollow shaft.

17. The hollow shaft barbeque tool as set forth in claim 1, wherein the tip receiver is positioned within the hollow shaft with a pin passing through both the hollow shaft and the tip receiver.

18. The hollow shaft barbeque tool as set forth in claim 1, wherein the tip receiver is screwed into the hollow shaft via threads.

19. The hollow shaft barbeque tool as set forth in claim 1, wherein the hollow shaft is formed to be collapsible from an extended position to a collapsed position.
